(19) United States
(12) Patent Application Publication
(10) Pub. No.: US 2005/0041779 A1
(43) Pub. Date: Feb. 24, 2005

(54) X-ray zoom lens

(75) Inventors: Alan George Michette, Strand (GB); Philip Doughty Prewett, Edgbaston (GB)

Correspondence Address: NIXON & VANDERHYE, PC, 1100 N GLEBE ROAD, 8TH FLOOR, ARLINGTON, VA, 22201-4714, US

(73) Assignee: BTG International Limited, London (GB)

(21) Appl. No.: 10/949,324

(22) Filed: Sep. 27, 2004

Related U.S. Application Data
(63) Continuation of application No. 10/130,981, filed on Aug. 19, 2002, now abandoned.

(30) Foreign Application Priority Data
Nov. 24, 1999 (GB) 9927631.3
Jul. 26, 2000 (GB) 0018332.7

(51) Int. Cl. G21K 1/06

(52) U.S. Cl. 378/84

(57) ABSTRACT

An optical array focussing X-rays comprises a plate e.g. made of silicon, on which are etched a series of concentric gaps to form channels through the plate, when X-rays are incident on the plate they are reflected from the inside of the channels to a focus. Preferably the plate can be curved to increase the magnification.

The present invention relates to an X-ray optic and more particularly it relates to an optical arrangement which can focus electromagnetic radiation in the range of frequencies commonly referred to as X-ray.

Focussed X-rays are or have the potential to be used in a wide range of applications such as X-ray lithography for the manufacture of micro-chips and for micro-machining, in spatially resolved X-ray fluorescence analysis, sub-cellular probing, X-ray microscopy and in scientific instrument manufacture. In these applications an intense X-ray source is required and the ability to focus X-rays can increase the useable source intensity.

Known methods for producing focussed X-rays include the use of diffractive optical components (zone plates) or multilayer mirrors. Although zone plates are capable of forming high-resolution images they, and multilayer mirrors, suffer from several drawbacks such as low efficiencies, the need for monochromatic illumination and small zone plate apertures.

Grazing incidence reflective optics are widely used in several applications but have not been used in high resolution imaging systems because of aberrations. Systems which have been used mainly for hard X-ray applications are Kirkpatrick-Baez optics. Wolter optics microcapillary optics polycapillary optics and micro channel plate arrays.

In polycapillary optics, which are described in articles by M A Kumakov 1998 Proc. SPIE 3444 pps. 424429 and by H N Chapman. K A Nugent, S W Wikins 1991 Rev. Sci. Insrum. 62 1542-1361, a series of small (10⁻⁶ m) curved channels are used and X-rays are transmitted down the channels and use grazing incidence reflection to focus the X-rays. Although polycapillary optics have large apertures, large bandpass and high transmission efficiency they are difficult to design and manufacture as several constraints have to be overcome, these include the limitation that the channel width, cross sectional shape and curvature are such that there are only a few reflections down each channel (ideally two) as, with more than two reflections, correspondence between object and image conjugate points may be lost, so it is necessary to vary channel width, shape and curvature along the length of the channels. The open area of the channels at the optic entrance should be a large percentage of the total area (>80%), however a large open area makes the optic very fragile and variation in reflectivities, absorption and scattering due to surface roughness are disadvantages.

We have devised an X-ray optical system based on a microstructured optical array (MOA) which overcomes many of the disadvantages of existing systems. In addition, and most importantly, it can be used as an X-ray zoom lens, allowing variable magnification and control of focal length According to the invention there is provided an optical array which comprises a plate, the surface of which is formed of a plurality of X-ray transparent zones separated by X-ray opaque bands, the X-ray opaque bands being of a thickness such that, when a beam of X-rays from a source is projected onto the plate, at least some of the X-rays are reflected off the outermost walls of the said bands and there being a control means able to shape the plate to form a curved surface so as to be able to focus X-rays passing through the plate.

In an alternative aspect, there is provided an optical array comprising a plurality of X-ray opaque bands separated by X-ray transparent zones, the X-ray opaque bands being dimensioned such that, when a beam of X-rays from a source is projected onto the array, at least some of the X-rays are reflected off walls of the said bands, the array being deformable to dynamically vary the angle of reflection of said X-rays.

There is also provided a method of focussing a beam of X-rays employing the optical array of the present invention.

By thickness of the X-ray opaque bands is meant the distance measured from the base of the bands to its top i.e. the height above the adjacent X-ray transparent zone.

The zones are preferably in the form of rings and that the structure comprises a plurality of X-ray transparent channels separated by X-ray opaque walls. The rings on the plate can be in the form of concentric circles or they can be elliptical, oval etc.

The walls preferably have a height such that there is at least one reflection in each channel and, in a thin flat plate, a small variation of angle of incidence of the X-ray on the outer wall of the channels can be used for one to one imaging, but channel diameters must be small to reduce losses due to unreflected X-rays, however if the channel diameters are too small some X-rays may undergo double reflections from both wall of the channels and be lost. If the plate is thicker aberrations can be induced as the incidence angle varies along the channel, but fewer X-rays pass right through.

The dimensions of the plate will depend on the application.

The width of the channels preferably increases radially outwards to allow for the increasing incidence angle and preferably the width of the channels is larger than the width of the X-ray opaque sections between the channels. The width of the channels will depend on the application.

The plate can be formed by directly etching a substrate formed of an X-ray opaque material so that the X-ray transparent channels are formed through the plate, or by depositing rings of X-ray opaque material onto a substrate in the form of a plate or membrane to build up the structure of the invention.

When the structure is built up on a plate or membrane a lost mould process can be used. In this process a structure of the size and shape of the optical array is fabricated in a material which can be removed e.g. by melting, and a mould is formed from this structure and the material removed. This mould is then used to form the optical array of the invention.

Materials which can be used to form the array include metals such as nickel and these can be supported on a substrate if required. The channel walls must be smooth to prevent loss of reflectivity. Typical roughness must be less than a fraction of a wavelength, which can be achieved for X-rays with electroplated nickel.

Other suitable material from which the plate can be made include silicon, silicon carbide and the plate can be formed from a single silicon wafer of the type made commercially by Virginia semiconductors Inc. Such a silicon wafer can be patterned to form the structure of the invention e.g. by isotropic plasma etching, lithography etc.

To focus the X-rays transmitted through the plate the plate is curved and the greater the degree of curvature the shorter the focal length of the array. The curvature can be spherical, parabolic, etc. and the degree of curvature can be varied depending on the wavelength of the X-rays, the distance of the X-ray source from the plate and the purpose of the focussed beam of X-rays etc. The degree of curvature and hence magnification achievable will be limited by the elasticity and stability of the material of the plate under bending stresses. The ability to vary the curvature enables an X-ray zoom lens to be obtained

The plate can be curved by any suitable method either before or after forming the structure of the invention. For example, when the plate is made of silicon, a method of forming the curvature of the plate is to deposit a prestressed layer on the silicon wafer after it has been patterned to give a biomorph stress induced curvature. For example radial ribs of silicon are coated with a metal film which, when cooled will be in compressive stress. The degree of curvature and hence the focal length of the structure can be changed by varying the temperature at specific points by localised heating e.g. using miniature heaters.

Another method of curving the plate is to apply a differential pressure across the plate so that the plate is curved. For example the structure of the invention is formed on a silicon wafer by lithography the plate mounted in a sealed chamber with helium, which is X-ray transmissive, on one or both sides of the plate, by varying the differential pressure the degree of curvature can be varied.

An alternative method of curving the plate is to coat the plate with a piezoelectric material so that variation in an electric current applied to the piezoelectric material will vary the curvature of the plate.

The ability to vary the curvature whichever method is used, enables an X-ray zoom lens to be formed and X-rays can be focussed to provide a concentrated beam of X-rays with a controlled degree of concentration. This enables the MOAs of the present invention to give enhanced performance in existing or potential applications such as X-ray lithography, spatially resolved X-ray fluorescence analysis, sub-cellular probing, X-ray microscopy and in scientific instrument manufacture, imaging X-ray microscopy spatially resolved fluorescence microscopy, photemission microscopy and astronomy.

The present invention is not wavelength specific and can be used with hard X-rays and soft X-rays of a range of wavelengths, including the range of wavelengths commonly referred to as Extreme Ultraviolet (EUV).

The invention is illustrated in the drawings in which:—

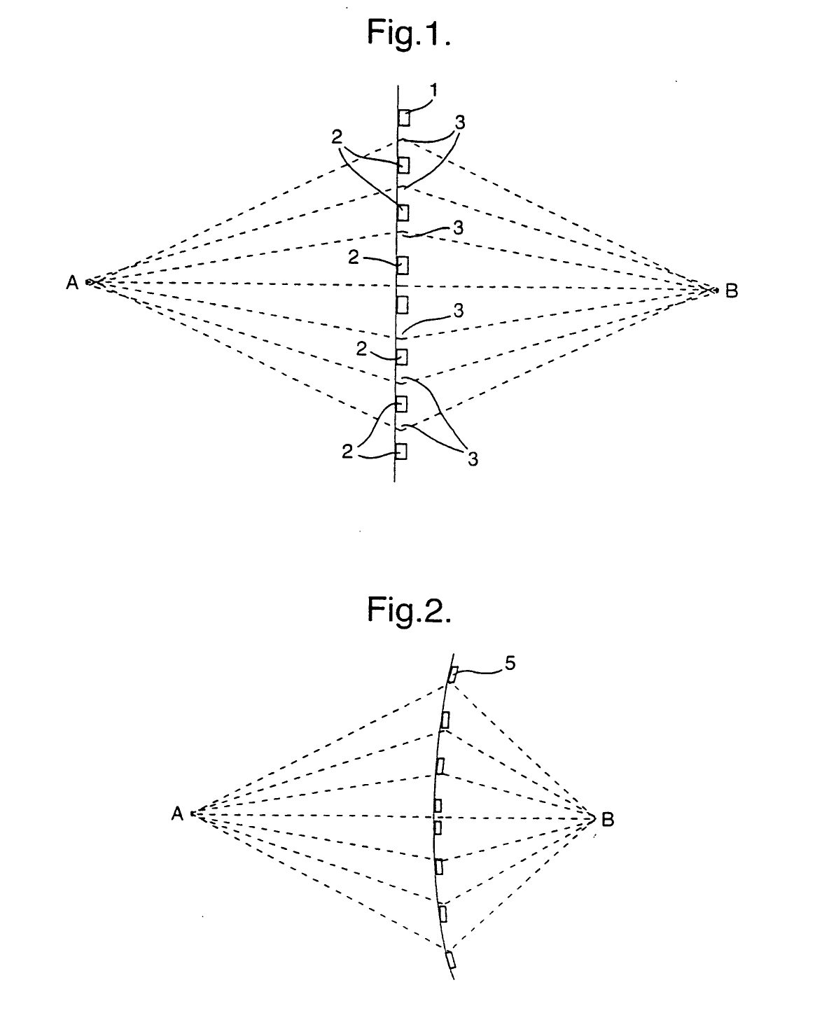

FIG. 1 is a schematic side view of a flat MOA

FIG. 2 is a schematic side view of a curved MOA

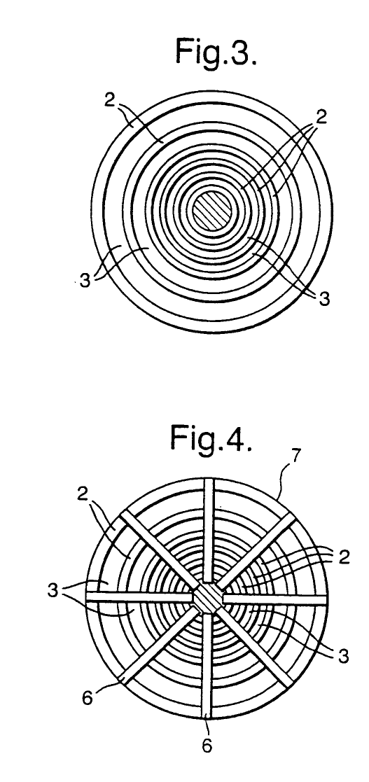

FIG. 3 is a front view of FIG. 2

FIG. 4 is a front view showing the use of a biomorph and

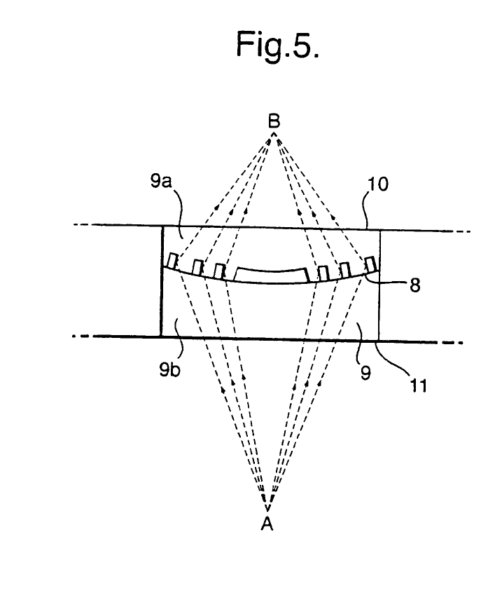

FIG. 5 is a schematic view of the use of pressure to bend the MOA In the drawings one reflection is shown although in practice there can be more than one.

Referring to FIG. 1 a plate (1) formed from a silicon wafer has gaps (3) etched on its surface by isotropic plasma etching so as to form a series of concentric X-ray opaque bands of silicon (2) and X-ray transparent gaps (4). The gaps (3) are wider than the bands (2) to give an open web structure. In practice there will be many more bands than are illustrated. The plate can be fabricated by depositing bands (2) onto a substrate (1).

When X-rays from source A impinge on the plate (1) X-rays are reflected off the inner surface of (2) to focus at B as shown.

Referring to FIG. 2 the plate (5) is curved as shown so that the X-rays from source A are focussed at (B) so that there is concentration of the X-rays.

Referring to FIG. 4, in order to curve the plate (7) radial ribs (6) are formed of a metal such as nickel so that, as the metal cools, there is a biomorph induced stress which curves the plate (7) to form the shape shown in FIG. 2.

If the ribs are coated with a piezo electric material the curvature can be electrically controlled by varying the current applied to the coating.

Alternatively the plate can be curved by localised heating.

Referring to FIG. 5 a plate (8) is placed in a sealed pressure chamber (9) so that the two sections (9a) and (9b) are separated by the plate (8). The chamber is sealed by pressure sealing caps (10) and (11) and the sections (9a) and (9b) contain helium. By increasing the pressure PA in (9a) in relation to PB (9b) the plate (8) is curved as shown. One of the sections (9a) or (9b) can be exposed to atmospheric pressure.

Each of the above enable the curvature to be varied and so the focus B of X-rays from source A can be changed, allowing the plate to act as an X-ray zoom lens shortened to increase the magnification.

1. An optical array which comprises a plate, the surface of which is formed of a plurality of X-ray transparent zones separated by X-ray opaque bands, the X-ray opaque bands being of a thickness such that, when a beam of X-rays from a source is projected onto the plate, at least some of the X-rays are reflected off the outermost walls of the said bands and there being a control means able to shape the plate to form a curved surface so as to be able to focus X-rays passing through the plate.

2. An optical array as claimed in claim 1 in which the X-ray transparent zones are in the form of rings and that the structure comprises a plurality of X-ray transparent channels separated by X-ray opaque walls.

3. An optical array as claimed in claim 2 in which the rings on the plate are in the form of concentric circles or ellipses.

4. An optical array as claimed in claim 1 in which the X-ray opaque bands have a thickness such that there is at least one reflection in each channel.

5. An optical array as claimed in claim 1 in which the width of the channels increases radially outwards to allow for the increasing incidence of incidence.

6. An optical array as claimed in claim 1 in the width of the channels is larger than the width of the X-ray opaque sections between the channels.

7. An optical array as claimed in claim 1 in which the plate is made from silicon.

8. An optical array as claimed in claim 1 in which the plate is made from electroplated nickel.

9. An optical array which is an X-ray zoom lens which comprises an array as claimed in claim 1 in which the control means can be controlled to vary the amount of curvature of the plate and to form an X-ray lens the focal length of which is controlled by the control means.

10. An optical array as claimed in claim 9 in which the control means comprises radial ribs of silicon or a metal attached to or forming part of the plate so that when the ribs of silicon or a metal cooled they will be in compressive stress and cause the plate to form a curved shape.

11. An optical array as claimed in claim 9 in which the control means comprises means to apply a differential pressure across the plate.

12. An optical array as claimed in claim 9 in which the control means comprises a piezoelectric material in contact with of forming part of the plate so that variation in an electric current applied to the piezoelectric material will vary the curvature of the plate.

13. An optical array as claimed in claim 12 in which the control means comprises localised heating means.

14. An optical array which is an X-ray zoom lens which comprises an array as claimed in claim 1 in which the control means can be controlled to vary the amount of curvature of the plate and to form an X-ray lens the focal length of which is controlled by the control means.

15. Apparatus for using X-rays incorporating an array as claimed in claim 1.

16. Apparatus as claimed in claim 15 in which the apparatus is selected from apparatus for X-ray lithography, spatially resolved X-ray fluorescence analysis, sub-cellular probing, X-ray microscopy, imaging X-ray microscopy, spatially resolved fluorescence microscopy, photemission microscopy and astronomy.

17. Optical array comprising a plurality of X-ray opaque bands separated by X-ray transparent zones, the X-ray opaque bands being dimensioned such that, when a beam of X-rays from a source is projected onto the array, at least some of the X-rays are reflected off walls of the said bands, the array being deformable to dynamically vary the angle of reflection of said X-rays.

18. Method of focussing a beam of X-rays wherein an optical array according to claim 1 is positioned in the path of said X-rays.
